(19) United States
(12) Patent Application Publication
(10) Pub. No.: US 2010/0231125 A1
(43) Pub. Date: Sep. 16, 2010

(54) ORGANIC LIGHT EMITTING DEVICE TO EMIT IN NEAR INFRARED

(76) Inventors: SHENG LI, VISTA, CA (US); AMANE MOCHIZUKI, SAN DIEGO, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/403,265

(22) Filed: Mar. 12, 2009

(51) Int. Cl. H01J 1/63; C09K 11/06; C09K 11/02

(52) U.S. Cl. 313/504; 252/301.16; 252/301.35

(57) ABSTRACT

Compositions and light-emitting devices related to compounds represented by Formula I are disclosed herein.

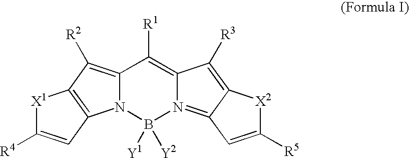

### BACKGROUND

1. Field of the Invention

This invention relates to organic light-emitting diode devices and emissive compositions related to these devices.

2. Description of the Related Art

An organic light emitting diode (OLED) is a multilayer electroluminescent device comprising an anode, a cathode, and an organic emissive layer that is sandwiched in between the anode and the cathode. Depending on the emissive dyes being used, an OLED device can be made to emit in visible light monochromatically or white light. An OLED device can also be made to emit outside of the visible range, such as in ultraviolet (UV), in infrared (IR), or in near infrared (NIR) region. OLEDs that emit near-infrared (NIR) light may have potential in laser technology, optical sensors, and telecommunications. However, only a few materials are available for the use of NIR OLEDs. These materials include low band-gap polymers, molecules containing rare-earth metals such as Nd³⁺, Er³⁺, small molecule host-guest system, and small molecules doped in a polymer matrix. Furthermore, even though there are relatively few materials useful for NIR OLEDS, many of these materials are too unstable to be ideal for use in many devices. Thus, there is a need for additional materials for NIR OLEDs.

Among many OLED device configurations, host-guest (dopant) type devices may have advantages such as simple processing, solution processability, high efficiency, fewer layers, cost effectiveness and large area production.

### SUMMARY OF THE INVENTION

Some embodiments provide a composition comprising: a host comprising at least one of a hole-transport material, an electron-transport material, and an ambipolar material; and an emissive compound represented by Formula I:

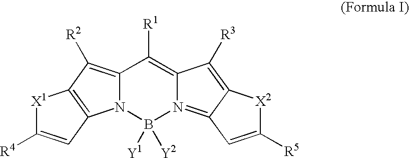

wherein R¹ is C₁₋₆ haloalkyl, —CN, optionally substituted C₆₋₁₀ aryl, or optionally substituted C₃₋₉ heteroaryl; R² and R³ are independently H or C₁₋₆ alkyl; R⁴ and R⁵ are independently C₁₋₆ alkyl, —O—C₁₋₆ alkyl, —S—C₁₋₆ alkyl, or NR′R″, wherein R′ and R″ are independently: H or C₁₋₆ alkyl, optionally substituted C₆₋₁₀ aryl, or optionally substituted C₃₋₉ heteroaryl; X¹ and X² are independently O, S, or NR, wherein R is H or C₁₋₆ alkyl; and Y¹ and Y² are independently halogen, —CN, optionally substituted C₆₋₁₀ aryl, or optionally substituted C₃₋₉ heteroaryl.

Other embodiments provide an organic light emitting diode device comprising: an anode layer; a cathode layer; and a light-emitting layer positioned between, and electrically connected to, the anode layer and the cathode layer; wherein the light-emitting layer comprises a host and an emissive compound as described herein.

Other embodiments provide an organic light emitting diode device comprising: an anode layer; a cathode layer; and a light-emitting layer positioned between, and electrically connected to, the anode layer and the cathode layer; wherein the light-emitting layer comprises: from about 1% (w/w) to about 10% (w/w) of 2,8-di(4-methoxyphenyl)-11-trifluoromethyl-difuro[2,3-b]-[3,2-g]-5,5-difluoro-5-bora-3a,4a-diaza-s-indacene; poly(9-vinylcarbazole); and 2-(4-biphenylyl)-5-(4-tert-butylphenyl)-1,3,4-oxadiazole.

These and other embodiments are described in greater detail below.

### BRIEF DESCRIPTION OF THE DRAWINGS

FIG. 1 depicts the configuration of one embodiment of an organic light emitting diode (OLED) device described herein.

FIG. 2 depicts the electroluminescence spectrum of one embodiment of an OLED device described herein.

FIG. 3 is a plot depicting the I-V-R curve of one embodiment of an OLED device described herein.

FIG. 4 is a plot depicting external quantum efficiency (EQE) vs. current density of one embodiment of an OLED device described herein.

### DETAILED DESCRIPTION OF THE PREFERRED EMBODIMENT

### Definitions

The term “alkyl” refers to a hydrocarbon moiety having no double or triple bonds. Alkyl includes linear, branched, and/or cyclic structures. “C₁₋₆ alkyl” refers to alkyl having 1, 2, 3, 4, 5, or 6 carbon atoms such as methyl (—CH₃), ethyl (—CH₂CH₃), propyl isomers (—C₃H₇), butyl isomers (—C₄H₉), cyclopropyl, cyclobutyl, etc.

The term “haloalkyl” refers to alkyl having one or halogen substituents. The term “fluoroalkyl” refers to alkyl having one or more fluoro substituents. The term “perfluoroalkyl” refers to a fully fluorinated fluoroalkyl moiety having no double or triple bonds. Perfluoroalkyl includes linear, branched, and/or cyclic structures. “C₁₋₆ perfluoroalkyl” refers to perflouroalkyl having 1, 2, 3, 4, 5, or 6 carbon atoms such as perfluoromethyl (CF₃), perfluoroethyl (CF₂CF₃), perfluoropropyl isomers (C₃F₇), perfluorobutyl isomers (C₄F₉), perfluorocyclopropyl (cyclic C₃F₆), perfluorocyclobutyl (cyclic C₄F₈) etc.

The expression “—O—C₁₋₆ alkyl” refers to —O— directly attached to C₁₋₆ alkyl such as —O—CH₃, —O—CH₂CH₃, —O—C₃H₇, etc.

The expression “—S—C₁₋₆ alkyl” refers to —S— directly attached to C₁₋₆ alkyl such as —S—CH₃, —S—CH₂CH₃, —S—C₃H₇, etc.

The term “aryl” refers to an all carbon aromatic ring or ring system. The term “optionally substituted aryl” refers to aryl which is either unsubstituted or is substituted. Substituted aryl has one or more moieties other than hydrogen, called substituents, covalently bonded to a ring carbon atom. In some embodiments, the substituents can be any moiety known in the art to be a substituent on aryl such as at least one of: C₁₋₁₂ hydrocarbyl (meaning a hydrocarbon moiety), a C₁₋₁₂ ether (meaning hydrocarbyl with one or more CH₂ replaced with O such as alkoxy, alkoxyalkyl, etc.), a C₁₋₁₂ thioether (meaning hydrocarbyl with one or more CH₂ replaced with S such as alkylthio, alkylthioalkyl, etc.), a C₁₋₁₂ amine (meaning hydrocarbyl with one or more CH replaced with N such as —NH₂, —NH(alkyl), —N(alkyl¹)(alkyl²), -alkylNH(alkyl), -alkylN(alkyl¹)(alkyl²), -alkylNHalkyl¹N(alkyl²)(alkyl³), etc.), a C₁₋₁₂ ester (meaning hydrocarbyl with one or more CH₂ replaced with CO₂ such as alkylcarboxylate, acyloxy, alkylalkanoate, etc.) a C₁₋₁₂ ketone (meaning hydrocarbyl with one or more CH₂ replaced with CO in a non-terminal position, such as acyl, acylalkyl, etc), a C₁₋₁₂ amide (meaning hydrocarbyl with one or more CH₂ replaced with CON, such as —NHCOalkyl, —CONHalkyl, —N(alkyl¹)COalkyl², —CON(alkyl1)alkyl2, alkylNHCOalkyl¹, alkylN(alkyl¹)COalkyl², a C₁₋₁₂ carboxylic acid (meaning —CO₂H or -hydrocarbylCO₂H) a C₁₋₁₂ alcohol (meaning hydrocarbyl with one or more H replaced with —OH such as hydroxyalkyl, dihydroxylalkyl, etc.), a C₁₋₁₂ thiol (meaning hydrocarbyl with one or more H replaced with —SH), a C₁₋₁₂ sulfonic acid (meaning —SO₃H or -hydrocarbylCO₃H), a C₁₋₁₂ sulfonic acid derivative [meaning groups where CH₂ is replaced with SO₂N (sulfonamide), SO₃ (sulfonyl ester), SO₂ (sulfone), etc.), F, Cl, Br, I, —CN, —NO₂, aryl, heteroaryl; or hydrocarbyl, aryl, or heteroaryl substituted with one or more of any one, or combination of, the groups above, up to C₁₂]. In one embodiment, the substituents include at least one of C₁₋₁₂ alkyl, a C₁₋₁₂ ether, a C₁₋₁₂ thioether, a C₁₋₁₂ amine, a C₁₋₁₂ ester, a C₁₋₁₂ ketone, a C₁₋₁₂ thiol, F, Cl, Br, I, —CN, CF₃, and —NO₂. Optionally substituted aryl may have as many substituents as there are hydrogen atoms covalently bonded to a ring carbon in the corresponding unsubstituted aryl. The term “optionally substituted C₆₋₁₀ aryl” refers to aryl having from 6-10 carbon atoms in the ring or ring system. The substituents are not referred to in the designation “C₆₋₁₀.”

The term “heteroaryl” refers to an aromatic ring or ring system which has one or more O, N, and/or S atoms in the ring or ring system. Examples of heteroaryl include pyridine, thienyl, furyl, imidazolyl, thiazolyl, oxazolyl, etc. The term “optionally substituted heteroaryl” is either unsubstituted or is substituted. The substituents of substituted heteroaryl are the same as those of optionally substituted aryl. Optionally substituted heteroaryl may have as many substituents as there are hydrogen atoms covalently bonded to a ring atom in the corresponding unsubstituted heteroaryl. The term “optionally substituted C₃₋₉ heteroaryl” refers to aryl having from 3-9 carbon atoms in the ring or ring system. The substituents are not referred to in the designation “C₃₋₉.”

A hyphen (-) is intended to indicate a point of attachment to the remainder of a structure. For example, in —CN, the moiety attaches to the remainder of the molecule at the carbon atom.

An embodiment provides an emissive compound represented by Formula I:

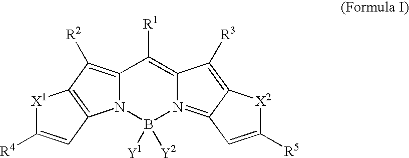

wherein R¹ is C₁₋₆ haloalkyl, —CN, optionally substituted C₆₋₁₀ aryl, or optionally substituted C₃₋₉ heteroaryl; R² and R³ are independently H or C₁₋₆ alkyl; R⁴ and R⁵ are independently C₁₋₆ alkyl, —O—C₁₋₆ alkyl, —S—C₁₋₆ alkyl, or NR′R″, wherein R′ and R″ are independently: H or C₁₋₆ alkyl, optionally substituted C₆₋₁₀ aryl, or optionally substituted C₃₋₉ heteroaryl; X¹ and X² are independently O, S, or NR, wherein R is H or C₁₋₆ alkyl; and Y¹ and Y² are independently halogen, —CN, optionally substituted C₆₋₁₀ aryl, or optionally substituted C₃₋₉ heteroaryl.

In some embodiments R¹ may be C₁₋₆ perfluoroalkyl, —CN, optionally substituted C₆₋₁₀ aryl, or optionally substituted C₃₋₉ heteroaryl. In some embodiments, R¹ may be CF₃, C₂F₅, C₃F₇, C₄H₉, —CN, or optionally substituted phenyl. In some embodiments, X¹ and X² may be O. In some embodiments Y¹ and Y² may independently be F, Cl, Br, or I. In some embodiments R⁴ and R⁵ may be optionally substituted C₆₋₁₀ aryl, such as optionally substituted phenyl; or optionally substituted C₃₋₉ heteroaryl, such as optionally substituted thienyl, optionally substituted furyl, or optionally substituted pyridinyl.

Some embodiments provide an emissive compound represented by Formula II:

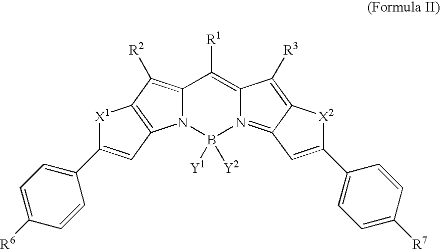

wherein R¹, R², R³, X¹, X², Y¹, and Y² are as described above, and R⁶ and R⁷ are independently hydrogen, C₁₋₆ alkyl (such as, while not intending to be limiting, CH₃, C₂H₅, C₃H₇, C₄H₉, etc.), C₁₋₆ —O-alkyl (such as, while not intending to be limiting, —O—CH₃, —O—C₂H₅, —O—C₃H₇, —O—C₄H₉, etc.), C₁₋₆ —S-alkyl (such as, while not intending to be limiting, —S—CH₃, —S—C₂H₅, —S—C₃H₇, —S—C₄H₉, etc.), or —NR⁸R⁹, and R⁸ and R⁹ are independently H or C₁₋₆ alkyl (such as, while not intending to be limiting —NH₂, —NHCH₃, —N(CH₃)₂—N(CH₂CH₃)₂, etc).

Some embodiments provide 2,8-di(4-methoxyphenyl)-11-trifluoromethyl-difuro[2,3-b]-[3,2-g]-5,5-difluoro-5-bora-3a,4a-diaza-s-indacene (BDF-NIR1), represented by Formula III, as an emissive compound.

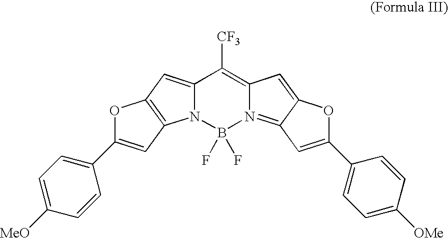

The compositions disclosed herein may be useful in preparing light-emitting devices. In some embodiments, devices prepared from some of the compositions disclosed herein may exclusively emit sharp near-infrared light. In other embodiments, the devices have a maximum emission at a wavelength in the rage of from about 720 nm to about 850 nm. With respect to light emitting diodes, the emissive compounds disclosed herein may have sustainable photostability compared to some rare-earth metal containing dyes.

In some embodiments, an organic light-emitting diode device may be fabricated which comprises a cathode, an anode, and a light-emitting layer comprising a host and an emissive compound disclosed herein. The light-emitting layer is disposed between the anode and the cathode, and is electrically connected to the anode and the cathode. In some embodiments, a hole-transport layer may be disposed between the anode and the light-emitting layer. Additionally, in some embodiments, an electron-transport layer may be disposed between the cathode and the light-emitting layer.

The anode layer may comprise a conventional material such as a metal, mixed metal, alloy, metal oxide or mixed-metal oxide, or conductive polymer, or an inorganic material such as carbon nanotube (CNT). Examples of suitable metals include the Group 1 metals, the metals in Groups 4, 5, 6, and the Group 8-10 transition metals. If the anode layer is to be light-transmitting, metals in Group 10 and 11, such as Au, Pt, and Ag, or mixed-metal oxides of Group 12, 13, and 14 metals or alloys thereof, such as indium-tin-oxide (ITO), indium-zinc-oxide (IZO), and the like, may be used. In some embodiments, the anode layer may be an organic material such as polyaniline. The use of polyaniline is described in “Flexible light-emitting diodes made from soluble conducting polymer,” Nature, vol. 357, pp. 477-479 (11 Jun. 1992). Examples of suitable high work function metals and metal oxides include but are not limited to Au, Pt, or alloys thereof, ITO, IZO, and the like. In some embodiments, the anode layer can have a thickness in the range of about 1 nm to about 1000 nm.

The cathode layer may include a material having a lower work function than the anode layer. Examples of suitable materials for the cathode layer include those selected from alkali metals of Group 1, Group 2 metals, Group 12 metals including rare earth elements, lanthanides and actinides, materials such as aluminum, indium, calcium, barium, samarium and magnesium, and combinations thereof Li-containing organometallic compounds, LiF, and Li₂O may also be deposited between the organic layer and the cathode layer to lower the operating voltage. Suitable low work function metals include but are not limited to Al, Ag, Mg, Ca, Cu, Mg/Ag, LiF/Al, CsF, CsF/Al or alloys thereof. In some embodiments, the cathode layer can have a thickness in the range of about 1 nm to about 1000 nm.

The emissive layer is a composition which is luminescent in an electric field. Preferably, but not necessarily, the composition has substantial emission in the red to near infrared region. In one embodiment, the composition has its maximum emission in the range of from about 720 nm to about 850 nm, about 730 nm to about 780 nm, or alternatively, about 750 nm. In some embodiments, the emissive layer is a solid composition.

The emissive layer comprises a host material and at least one of the emissive compounds disclosed herein. The amount of the emissive compound with respect to the host material may be any amount suitable to produce adequate emission. In some embodiments, the emissive compound is present at an amount of from about 0.1% (w/w) to about 10% (w/w), from about 0.1% (w/w) to about 5% (w/w), about 2% (w/w) to about 6% (w/w), or alternatively, about 4% (w/w), with respect to the weight of the host.

The host in the emissive layer may be at least one of one or more hole-transport materials, one or more electron-transport materials, and one or more ambipolar materials (i.e. materials capable of transporting both holes and electrons).

In some embodiments, the hole-transport material comprises at least one of an aromatic-substituted amine, a carbazole, a polyvinylcarbazole (PVK), e.g. poly(9-vinylcarbazole); N,N′-bis(3-methylphenyl)N,N′-diphenyl-[1,1′-biphenyl]-4,4′-diamine (TPD); polyfluorene; a polyfluorene copolymer; poly(9,9-di-n-octylfluorene-alt-benzothiadiazole); poly(paraphenylene); and poly[2-(5-cyano-5-methylhexyloxy)-1,4-phenylene].

In some embodiments, the electron-transport material comprises at least one of 2-(4-biphenylyl)-5-(4-tert-butylphenyl)-1,3,4-oxadiazole (PBD), 1,3-bis(N,N-t-butyl-phenyl)-1,3,4-oxadiazole (OXD-7), 1,3-bis[2-(2,2′-bipyridine-6-yl)-1,3,4-oxadiazo-5-yl]benzene, 3-phenyl-4-(1′-naphthyl)-5-phenyl-1,2,4-triazole (TAZ), 2,9-dimethyl-4,7-diphenyl-phenanthroline (bathocuproine or BCP), aluminum tris(8-hydroxyquinolate) (Alq3), and 1,3,5-tris(2-N-phenylbenzimidazolyl)benzene.

In some embodiments, the light-emitting layer comprises from about 50% (w/w) to about 80% (w/w) of poly(9-vinylcarbazole) and from about 20% (w/w) to about 50% (w/w) of the 2-(4-biphenylyl)-5-(4-tert-butylphenyl)-1,3,4-oxadiazole. In other embodiments, the light-emitting layer comprises: from about 4% (w/w) 2,8-di(4-methoxyphenyl)-11-trifluoromethyl-difuro[2,3-b]-[3,2-g]-5,5-difluoro-5-bora-3a,4a-diaza-s-indacene; about 58% (w/w) poly(9-vinylcarbazole); and about 38% (w/w) 2-(4-biphenylyl)-5-(4-tert-butylphenyl)-1,3,4-oxadiazole.

The thickness of the light-emitting layer may vary. In some embodiments, the light-emitting layer has a thickness from about 20 nm to about 200 nm. In some embodiments, the light-emitting layer has a thickness in the range of about 20 nm to about 150 nm.

In some embodiments, the light-emitting layer can further include additional host material which may have hole-transport, electron-transport, or ambipolar properties. Exemplary host materials are known to those skilled in the art. Examples of these additional host materials may include, but are not limited to: an aromatic-substituted phosphine, a thiophene, an oxadiazole, a triazole, 3,4,5-Triphenyl-1,2,3-triazole, 3,5-Bis(4-tert-butyl-phenyl)-4-phenyl[1,2,4]triazole, an aromatic phenanthroline, 2,9-Dimethyl-4,7-diphenyl-1,10-phenanthroline, a benzoxazole, a benzothiazole, a quinoline, a pyridine, a dicyanoimidazole, cyano-substituted aromatic, 4,4′-bis[N-(naphthyl)-N-phenyl-amino]biphenyl (α-NPD), 4,4′-bis[N,N′-(3-tolyl)amino]-3,3′-dimethylbiphenyl (M14), 4,4′-bis[N,N′-(3-tolyl)amino]-3,3′-dimethylbiphenyl (HMTPD), 1,1-Bis(4-bis(4-methylphenyl)aminophenyl)cyclohexane, 4,4′-N,N′-dicarbazole-biphenyl (CBP), poly(9-vinylcarbazole) (PVK), N,N′N″-1,3,5-tricarbazoloylbenzene (tCP), a polythiophene, a benzidine, N,N′-bis(4-butylphenyl)-N,N′-bis(phenyl)benzidine, a triphenylamine, 4,4′,4″-Tris(N-(naphthylen-2-yl)-N-phenylamino)triphenylamine, 4,4′,4″-tris(3-methylphenylphenylamino)triphenylamine (MTDATA), a phenylenediamine, a polyacetylene, and a phthalocyanine metal complex.

In some embodiments, the light-emitting device may further comprise a hole-transport layer disposed between the anode and the light-emitting layer. The hole-transport layer may comprise at least one hole-transport material. Suitable hole-transport materials may include those listed above in addition to others known to those skilled in the art. Exemplary hole-transport materials that can be included in the hole-transport layer included, but are not limited to: an optionally substituted compound selected from: 1,1-Bis(4-bis(4-methylphenyl)aminophenyl)cyclohexane; 2,9-Dimethyl-4,7-diphenyl-1,10-phenanthroline; 3,5-Bis(4-tert-butyl-phenyl)-4-phenyl[1,2,4]triazole; 3,4,5-Triphenyl-1,2,3-triazole; 4,4′,4″-Tris(N-(naphthylen-2-yl)-N-phenylamino)triphenylamine; 4,4′,4′-tris(3-methylphenylphenylamino)triphenylamine (MTDATA); 4,4′-bis[N-(naphthyl)-N-phenyl-amino]biphenyl (α-NPD); 4,4′-bis[N,N′-(3-tolyl)amino]-3,3′-dimethylbiphenyl (HMTPD); 4,4′-bis[N,N′-(3-tolyl)amino]-3,3′-dimethylbiphenyl (M14); 4,4′-N,N′-dicarbazole-biphenyl (CBP); 1,3-N,N-dicarbazole-benzene (mCP); poly(9-vinylcarbazole) (PVK); a benzidine; a carbazole; a phenylenediamine; a phthalocyanine metal complex; a polyacetylene; a polythiophene; a triphenylamine; an oxadiazole; copper phthalocyanine; N,N′-bis(3-methylphenyl)N,N′-diphenyl-[1,1′-biphenyl]-4,4′-diamine (TPD); N,N′N″-1,3,5-tricarbazoloylbenzene (tCP); N,N′-bis(4-butylphenyl)-N,N′-bis(phenyl)benzidine; and the like.

In some embodiments, the light-emitting device may further comprise an electron-transport layer disposed between the cathode and the light-emitting layer. The electron-transport layer may comprise at least one electron-transport material. Suitable electron transport materials include those listed above and others known to those skilled in the art. Exemplary electron transport materials that can be included in the electron transport layer include, but are not limited to: an optionally substituted compound selected from: aluminum tris(8-hydroxyquinolate) (Alq3), 2-(4-biphenylyl)-5-(4-tert-butylphenyl)-1,3,4-oxadiazole (PBD), 1,3-bis(N,N-t-butyl-phenyl)-1,3,4-oxadiazole (OXD-7), 1,3-bis[2-(2,2′-bipyridine-6-yl)-1,3,4-oxadiazo-5-yl]benzene (BPY-OXD), 3-phenyl-4-(1′-naphthyl)-5-phenyl-1,2,4-triazole (TAZ), 2,9-dimethyl-4,7-diphenyl-phenanthroline (bathocuproine or BCP), and 1,3,5-tris[2-N-phenylbenzimidazol-z-yl]benzene (TPBI). In one embodiment, the electron transport layer is aluminum quinolate (Alq3), 2-(4-biphenylyl)-5-(4-tert-butylphenyl)-1,3,4-oxadiazole (PBD), phenanthroline, quinoxaline, 1,3,5-tris[N-phenylbenzimidazol-z-yl]benzene (TPBI), or a derivative or a combination thereof.

If desired, additional layers may be included in the light-emitting device. These additional layers may include an electron injection layer (EIL), hole blocking layer (HBL), exciton blocking layer (EBL), and/or hole injection layer (HIL). In addition to separate layers, some of these materials may be combined into a single layer.

In some embodiments, the light-emitting device can include an electron injection layer between the cathode layer and the light emitting layer. In some embodiments, the lowest unoccupied molecular orbital (LUMO) energy level of the material(s) that can be included in the electron injection layer is high enough to prevent it from receiving an electron from the light emitting layer. In other embodiments, the energy difference between the LUMO of the material(s) that can be included in the electron injection layer and the work function of the cathode layer is small enough to allow efficient electron injection from the cathode. A number of suitable electron injection materials are known to those skilled in the art. Examples of suitable material(s) that can be included in the electron injection layer include but are not limited to, an optionally substituted compound selected from the following: aluminum quinolate (Alq3), 2-(4-biphenylyl)-5-(4-tert-butylphenyl)-1,3,4-oxadiazole (PBD), phenanthroline, quinoxaline, 1,3,5-tris[N-phenylbenzimidazol-z-yl]benzene (TPBI) a triazine, a metal chelate of 8-hydroxyquinoline such as tris(8-hydroxyquinoliate) aluminum, and a metal thioxinoid compound such as bis(8-quinolinethiolato) zinc. In one embodiment, the electron injection layer is aluminum quinolate (Alq3), 2-(4-biphenylyl)-5-(4-tert-butylphenyl)-1,3,4-oxadiazole (PBD), phenanthroline, quinoxaline, 1,3,5-tris[N-phenylbenzimidazol-z-yl]benzene (TPBI), or a derivative or a combination thereof.

In some embodiments, the device can include a hole blocking layer, e.g., between the cathode and the light-emitting layer. Various suitable hole blocking materials that can be included in the hole blocking layer are known to those skilled in the art. Suitable hole blocking material(s) include but are not limited to, an optionally substituted compound selected from the following: bathocuproine (BCP), 3,4,5-triphenyl-1,2,4-triazole, 3,5-bis(4-tert-butyl-phenyl)-4-phenyl-[1,2,4]triazole, 2,9-dimethyl-4,7-diphenyl-1,10-phenanthroline, and 1,1-bis(4-bis(4-methylphenyl)aminophenyl)-cyclohexane.

In some embodiments, the light-emitting device can include an exciton blocking layer, e.g., between the light-emitting layer and the anode. In one embodiment, the band gap of the material(s) that comprise exciton blocking layer is large enough to substantially prevent the diffusion of excitons. A number of suitable exciton blocking materials that can be included in the exciton blocking layer are known to those skilled in the art. Examples of material(s) that can compose an exciton blocking layer include an optionally substituted compound selected from the following: aluminum quinolate (Alq3), 4,4′-bis[N-(naphthyl)-N-phenyl-amino]biphenyl (α-NPD), 4,4′-N,N′-dicarbazole-biphenyl (CBP), and bathocuproine (BCP), and any other material(s) that have a large enough band gap to substantially prevent the diffusion of excitons.

In some embodiments, the light-emitting device can include a hole injection layer, e.g., between the light-emitting layer and the anode. Various suitable hole injection materials that can be included in the hole injection layer are known to those skilled in the art. Exemplary hole injection material(s) include an optionally substituted compound selected from the following: a polythiophene derivative such as poly(3,4-ethylenedioxythiophene (PEDOT)/polystyrene sulphonic acid (PSS), a benzidine derivative such as N,N,N′,N′-tetraphenylbenzidine, poly(N,N′-bis(4-butylphenyl)-N,N′-bis(phenyl)benzidine), a triphenylamine or phenylenediamine derivative such as N,N′-bis(4-methylphenyl)-N,N′-bis(phenyl)-1,4-phenylenediamine, 4,4′,4″-tris(N-(naphthylen-2-yl)-N-phenylamino)triphenylamine, an oxadiazole derivative such as 1,3-bis(5-(4-diphenylamino)phenyl-1,3,4-oxadiazol-2-yl)benzene, a polyacetylene derivative such as poly(1,2-bis-benzylthio-acetylene), and a phthalocyanine metal complex derivative such as phthalocyanine copper. Hole-injection materials, while still being able to transport holes, may have a hole mobility substantially less than the hole mobility of conventional hole transport materials.

Those skilled in the art recognize that the various materials described above can be incorporated in several different layers depending on the configuration of the device. In one embodiment, the materials used in each layer are selected to result in the recombination of the holes and electrons in the light-emitting layer.

Light-emitting devices comprising the compounds disclosed herein can be fabricated using techniques known in the art, as informed by the guidance provided herein. For example, a glass substrate can be coated with a high work functioning metal such as ITO which can act as an anode. After patterning the anode layer, a light-emitting layer that includes at least a compound disclosed herein can be deposited on the anode. The cathode layer, comprising a low work functioning metal (e.g., Mg:Ag), can then be vapor evaporated onto the light-emitting layer. If desired, the device can also include an electron transport/injection layer, a hole blocking layer, a hole injection layer, an exciton blocking layer and/or a second light-emitting layer that can be added to the device using techniques known in the art, as informed by the guidance provided herein.

In some embodiments, the OLED is configured by a wet process such as a process that comprises at least one of spraying, spin coating, drop casting, inkjet printing, screen printing, etc. Some embodiments provide a composition which is liquid suitable for deposition onto a substrate. The liquid may be a single phase, or may comprise one or more additional solid or liquid phases dispersed in it. The liquid comprises a light-emitting compound and a host material disclosed herein and a solvent.

### EXAMPLE 1

The following is an example of a synthesis of some embodiments providing compounds with emissive properties in the NIR region. However, a person of ordinary skill in the art will recognize that other methods are available for preparing these compounds, and that other embodiments may provide different compounds with NIR emissive properties by using or adapting chemistry which is known in art.

### Synthesis of an Embodiment of an NIR Dye

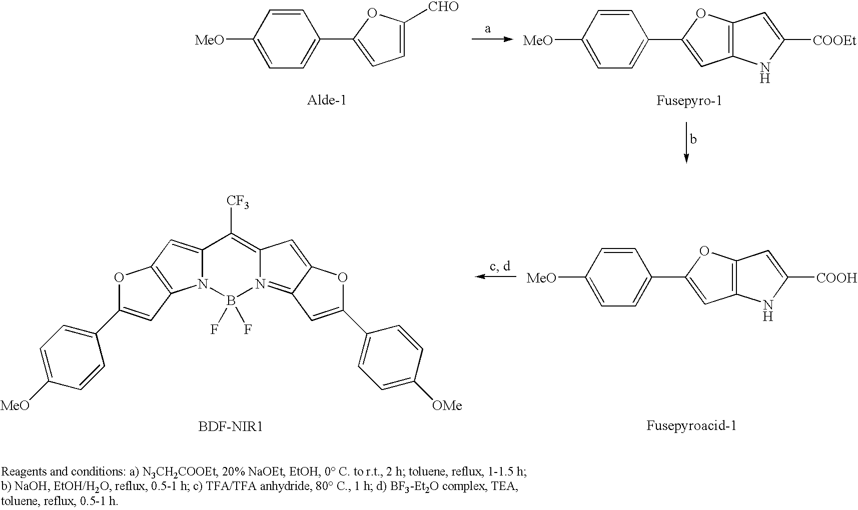

### Fusepyro-1

Alde-1 (3.39 g, 16.8 mmol) and ethyl azidoacetate (8.65 g, 67.0 mmol) were dissolved in anhydrous ethanol (300 ml) and stirred at 0° C. A solution of sodium ethoxide (20 wt % in ethanol, 22.8 g, 67.0 mmol) was added dropwise into the mixture, and stirred for 2 h. Excess saturated aqueous NH₄Cl solution was added to form a yellow precipitate, which was collected by filtration. The precipitate was washed with water and dried in vacuo. The resulting brown residue was dissolved in toluene (60 ml) and heated to reflux for 1.5 h. After cooling, the solvent was evaporated. The residue was purified by flash chromatography (silica gel, hexane/dichloromethane=10/90) to obtain the product Fusepyro-1 as a brown solid (2.32 g, 48.6%). 1H-NMR (CDCl3): 8.72 (s, 1H), 7.67 (d, 2H, J=9.0 Hz), 6.94 (d, 2H, J=9.0 Hz), 6.80 (s, 1H), 6.58 (s, 1H), 4.35 (q, 2H, J=7.1 Hz), 3.85 (s, 3H), 1.38 (t, 3H)

### Fusepyroacid-1

To a solution of Fusepyro-1 (1.90 g, 6.66 mmol) in ethanol (60 ml) was added NaOH (4.00 g, 0.1 mol) in water (30 ml) and the mixture was refluxed for 1 h. After cooling, concentrated aqueous HCl solution was added to acidify the mixture and it was filtered. The resulting precipitate was washed with water and dried in vacuo to obtain product Fusepyroacid-1 as a gray solid (1.56 g, 91.0%). 1H-NMR (DMSO-d6): 12.34 (s, 1H), 11.57 (s, 1H), 7.74 (d, 2H, J=8.7 Hz), 7.01 (d, 2H, J=8.7 Hz), 6.97 (s, 1H), 6.71 (s, 1H), 3.80 (s, 3H)

### BDF-NIR1

Fusepyroacid-1 (298 mg, 11.7 mmol) was dissolved in trifluoroacetic acid (15 ml) and stirred at 40° C. for 15 min. Trifluoroacetic anhydride (3 ml) was added into the reaction solution and stirring continued at 80° C. for 30 min (an intense green color appeared). After cooling, the reaction solution was poured into aqueous NaHCO₃ solution containing crushed ice. The precipitate was filtered, washed with water and dried in vacuo. The crude compound was dissolved in toluene (70 ml) and stirred at room temperature. Boron trifluoride diethyl ether complex (1.2 ml) and triethylamine (0.8 ml) were added into the reaction solution and stirring continued at 80° C. for 15 min. After cooling, the reaction solution was diluted with toluene and washed with saturated aqueous NaHCO₃ solution, water and brine, dried over Na₂SO₄, filtered and evaporated. The crude compound was purified by chromatography (silica gel, toluene/ethyl acetate=95/5) to obtain product BDF-NIR1 as a green metallic solid (188 mg, 58.4%). 1H-NMR (CDCl3): 7.80 (d, 4H, J=9.0 Hz), 7.00 (d, 4H, J=8.8 Hz), 6.82 (s, 2H), 6.73 (s, 2H), 3.90 (s, 6H).

### EXAMPLE 2

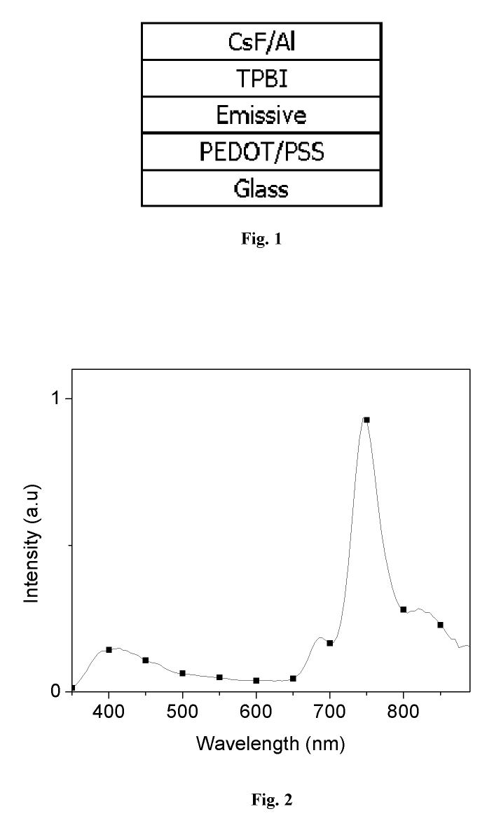

BDF-NIR1, prepared as described above, was used in the emissive layer of an OLED device. A schematic diagram of the device is depicted in FIG. 1, was prepared as follows. ITO-coated glass substrates were cleaned by ultrasound in acetone and 2-propanol, consecutively, then baked at 110° C. for 3 hours, followed by treatment with oxygen plasma for 5 min. A layer of PEDOT: PSS (Baytron P from H.C. Starck) was spin-coated at 3000 rpm onto the pre-cleaned and O₂-plasma treated (ITO)-substrate and annealed at 180° C. for 10 min, yielding a thickness of around 40 nm. Inside a glove-box that hosted vacuum deposition system a blend of PVK [57.69%(w/w)], PBD [38.64%(w/w)], and BDF-NIR1 [3.85% (w/w)] in chlorobenzene solution was spin-coated on top of the pretreated PEDOT:PSS layer, yielding a 70 nm thick emissive layer. Next a layer of 1,3,5-tris(N-phenylbenzimidizol-2-yl)benzene (TPBI) was deposited on top of the emissive layer at deposition rate around 0.06 nm/s at a pressure of 10⁻⁷ torr (1 torr=133.322 Pa). CsF and Al were then deposited successively at deposition rates of 0.005 and 0.2 nm/s, respectively. Each individual device had areas of 0.14 cm². All spectra were measured with an Ocean Optics HR 4000 spectrometer and I-V-L characteristics were taken with a Keithley 2400 SourceMeter and Newport 2832-C power meter and 818 UV detector. All device operation was performed inside a nitrogen-filled glove-box.

### EXAMPLE 3

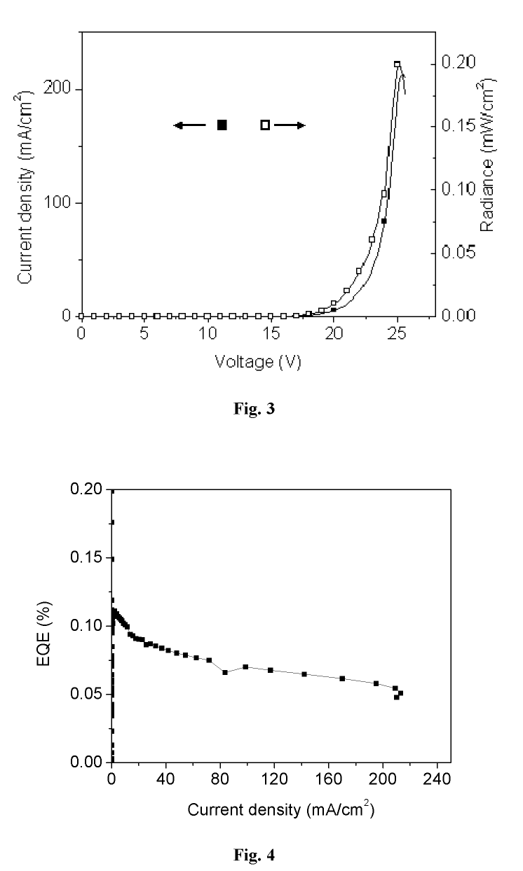

The electroluminescence spectrum, i.e. the emission spectrum of the device under an applied voltage, of the device prepared in example 2 is depicted in FIG. 2. The electroluminescence was measured by an Ocean Optics HR 4000 spectrometer. FIG. 2 shows that λₘₐₓ, i.e. the wavelength where emission is the highest, is 748 nm. Thus, the device substantially emits light in the near infrared region. FIG. 3 shows the current density and luminance as a function of the driving voltage (I-V-R characterization) of the device in example 2. FIG. 4 shows the EQE (external quantum efficiency) value as a function of current density of the device in example 2.

What is claimed is:

1. A composition comprising:
a host comprising at least one of a hole-transport material, an electron-transport material, and an ambipolar material; and
an emissive compound represented by Formula I: 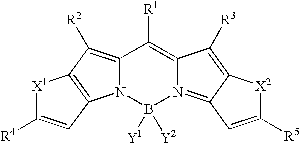
wherein R¹ is C₁₋₆ haloalkyl, —CN, optionally substituted C₆₋₁₀ aryl, or optionally substituted C₃₋₉ heteroaryl;
R² and R³ are independently H or C₁₋₆ alkyl;
R⁴ and R⁵ are independently C₁₋₆ alkyl, —O—C₁₋₆ alkyl, —S—C₁₋₆ alkyl, or NR′R″, wherein R′ and R″ are independently H or C₁₋₆ alkyl, optionally substituted C₆₋₁₀ aryl, or optionally substituted C₃₋₉ heteroaryl;
X¹ and X² are independently O, S, or NR, wherein R is H or C₁₋₆ alkyl; and
Y¹ and Y² are independently halogen, —CN, optionally substituted C₆₋₁₀ aryl, or optionally substituted C₃₋₉ heteroaryl.

2. The composition of claim 1 wherein R¹ is CF₃.

3. The composition of claim 1 wherein X¹ and X² are O.

4. The composition of claim 1 wherein Y¹ and Y² are F.

5. The composition of claim 1 wherein R⁴ and R⁵ are optionally substituted C₆₋₁₀ aryl or optionally substituted C₃₋₉ heteroaryl.

6. The composition of claim 1 wherein the emissive compound is further represented by Formula II: 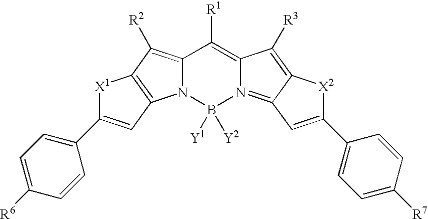
wherein R⁶ and R⁷ are independently hydrogen, C₁₋₆ alkyl, —O—C₁₋₆ alkyl, —S—C₁₋₆ alkyl, or —NR⁸R⁹, and R⁸ and R⁹ are independently H or C₁₋₆ alkyl.

7. The composition of claim 6 wherein the emissive compound is represented by Formula III:

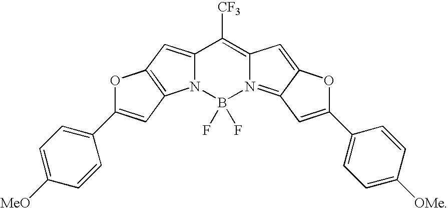

8. The composition of claim 7 wherein the compound is present at a concentration of from about 0.1% (w/w) to about 10% (w/w).

9. The composition of claim 1 wherein the hole-transport material comprises at least one of an aromatic-substituted amine, a carbazole, polyvinylcarbazole, and N,N′-bis(3-methylphenyl)N,N′-diphenyl-[1,1′-biphenyl]-4,4′-diamine, poly(9-vinylcarbazole), polyfluorene, a polyfluorene copolymer, poly(9,9-di-n-octylfluorene-alt-benzothiadiazole), poly(paraphenylene), and poly[2-(5-cyano-5-methylhexyloxy)-1,4-phenylene].

10. The composition of claim 9 wherein the hole-transport material comprises poly(9-vinylcarbazole).

11. The composition of claim 1 wherein the electron-transport material comprises at least one of 2-(4-biphenylyl)-5-(4-tert-butylphenyl)-1,3,4-oxadiazole, 1,3-bis(N,N-t-butyl-phenyl)-1,3,4-oxadiazole, 1,3-bis[2-(2,2′-bipyridine-6-yl)-1,3,4-oxadiazo-5-yl]benzene, 3-phenyl-4-(1′-naphthyl)-5-phenyl-1,2,4-triazole, 2,9-dimethyl-4,7-diphenyl-phenanthroline, aluminum tris(8-hydroxyquinolate), and 1,3,5-tris(2-N-phenylbenzimidazolyl)benzene.

12. The composition of claim 1 wherein the composition is a solid.

13. The composition of claim 1, wherein the composition is emissive.

14. The composition of claim 13 wherein the emissive composition is luminescent in an electric field, and the emissive composition has its maximum emission in the range of from about 720 nm to about 850 nm.

15. The composition of claim 1 wherein the composition comprises a liquid phase and is suitable for deposition onto a substrate.

16. The composition of claim 15 wherein the deposition onto a substrate comprises at least one of spraying, spin coating, drop casting, inkjet printing, and screen printing.

17. An organic light emitting diode device comprising:
an anode layer;
a cathode layer; and
a light-emitting layer positioned between, and electrically connected to, the anode layer and the cathode layer;
wherein the light-emitting layer comprises a composition of claim 1.

18. An organic light emitting diode device comprising:
an anode layer;
a cathode layer; and
a light-emitting layer positioned between, and electrically connected to, the anode layer and the cathode layer;
wherein the light-emitting layer comprises:
from about 1% (w/w) to about 10% (w/w) of 2,8-di(4-methoxyphenyl)-11-trifluoromethyl-difuro[2,3-b]-[3,2-g]-5,5-difluoro-5-bora-3a,4a-diaza-s-indacene;
poly(9-vinylcarbazole); and
2-(4-biphenylyl)-5-(4-tert-butylphenyl)-1,3,4-oxadiazole.

19. The device of claim 18 wherein the light-emitting layer comprises from about 50% (w/w) to about 80% (w/w) of poly(9-vinylcarbazole) and from about 20% (w/w) to about 50% (w/w) of the 2-(4-biphenylyl)-5-(4-tert-butylphenyl)-1,3,4-oxadiazole.
